(19) United States
(12) Patent Application Publication
(10) Pub. No.: US 2024/0078410 A1
(43) Pub. Date: Mar. 7, 2024

(54) SYSTEM AND METHOD FOR DYNAMIC-MODULAR-NEURAL-NETWORK-BASED MUNICIPAL SOLID WASTE INCINERATION NITROGEN OXIDES EMISSION PREDICTION

(71) Applicant: Beijing University of Technology, Beijing (CN)

(72) Inventors: Junfei Qiao, Beijing (CN); Haoshan Duan, Beijing (CN); Xi Meng, Beijing (CN); Jian Tang, Beijing (CN)

(21) Appl. No.: 18/450,945

(22) Filed: Aug. 16, 2023

(30) Foreign Application Priority Data
Aug. 18, 2022 (CN) 202210994681.2

(51) Int. Cl. G06N 3/045; F23G 5/50

(52) U.S. Cl. CPC G06N 3/045; F23G 5/50; F23G 2207/30; F23G 2207/60

(57) ABSTRACT

A dynamic modular neural network (DMNN) for NOx emission prediction in MSWI process is provided. First, the input variables are smoothed and normalized. Then, a feature extraction method based on principal component analysis (PCA) was designed to realize the dynamic division of complex conditions, and the prediction task to be processed was decomposed into sub-tasks under different conditions. In addition, aiming each sub-tasks, a long short-term memory (LSTM)-based sub-network is constructed to achieve accurate prediction of NOx emissions under various working conditions. Finally, a cooperative strategy is used to integrate the output of the sub-networks, further improving the accuracy of prediction model. Finally, merits of the proposed DMNN are confirmed on a benchmark and real industrial data of a municipal solid waste incineration (MSWI) process. The problem that the NOx emission of MSWI process is difficult to be accurately predicted due to the sensor limitation is effectively solved.

### FIELD

The invention relates in general to municipal solid waste incineration and intelligent modeling field, and in particular, to a system and method for dynamic-modular-neural-network-based municipal solid waste incineration nitrogen oxides emission prediction.

### BACKGROUND

MSWI is an effective measure for killing pathogens, reducing quantity and recycling resources. Thus, it is a universally accepted strategy for MSW disposal. However, the potential secondary pollution in MSWI process, such as nitrogen oxides (NOx), is the major reason for the not-in-my-back-yard effect. NOx is formed at a high temperature during combustion, causing damage to human health and environment. However, the existing technology can only measure NOx emission at current moment, and cannot provide the reference value of NOx emission at the future moment for operators, which will bring about problems such as lagging control means and excessive NOx emissions. Therefore, accurate prediction of NOx emission is of great significance to improve the efficiency of denitration system and ensure the safe and stable operation of MSWI plant.

### SUMMARY

The invention provides a prediction method for MSWI process based on a dynamic modular neural network (DMNN). The prediction model based on dynamic modular neural network was established to achieve accurate prediction of NOx emission in the future. DMNN is used to construct NOx emission prediction model, which can track the dynamic characteristics of MSWI process. Thus, accurate prediction of NOx emissions can be achieved.

In one embodiment, a system and method for dynamic-modular-neural-network (DMNN)-based municipal solid waste incineration (MSWI) process nitrogen oxides (NOx) emission prediction is provided. Sensor data associated with an MSWI process is obtained, the sensor data including a data set comprising a plurality of samples. The sensor data is preprocessed to remove those of the samples that comprise noise and to standardize the data set. A task of prediction of a NOx emission associated with an MSWI process is decomposed into a plurality of sub-tasks using principal component analysis, including applying a sliding window of a fixed size to the preprocessed sensor data set and identifying key variables of operating conditions of the MSWI process by key variables by applying a sliding window to the preprocessed sensor data set, each of the key variables associated with one of the sub-tasks. A long-short-term memory (LSTM) neural network is constructed, the LTSM neural network including a plurality of sub-networks, wherein each of the sub-networks outputs a value for one of the sub-tasks and a key variable associated with that sub-task serves as an input for that sub-network. A further set of sensor data associated with a further MSWI process is obtained, the further sensor data including further data samples; At least one of the further samples is compared to at least some of the samples in the preprocessed sensor data set; At least some of the sub-networks are activated based on the comparison. The activated subnetworks in the LTSM network are used to predict the NOx emission for the further MSWI process, wherein the steps are performed by at least one suitably-programmed computer and wherein a plant associated with the further MSWI process is operated based on the NOx prediction for the further MSWI process.

The technical scheme and steps of the invention are as follows:

As shown in FIG. 1. The related equipment of NOx emission prediction includes thermocouple temperature sensor, air volume sensor, liquid flow sensor, continuous emission monitoring system, distributed control system and upper computer. The continuous emission monitoring system includes a nitrogen oxide concentration detector. The detection instruments such as nitrogen oxide concentration detector, thermocouple temperature sensor, air volume sensor and liquid flow sensor are connected to the distributed control system through the fieldbus, and the data collected by sensors is transmitted to the I/O communication template. The analog voltage signal is converted into a digital signal that the computer can recognize through switch gating, amplifier and A/D converter and communicate with upper computer by industrial ethernet.

Through the switch gating in the communication template, the amplifier and A/D converter convert the analog voltage signal into the digital signal that the computer can recognize and communicate with the upper computer through the industrial Ethernet. The upper computer obtains the data of the MSWI process in real time and stores the collected data in the structured query language server database.

To obtain experimental data, the hardware storage device is used to read the historical data, which includes a total of 10 process variables and a NOx value to be predicted, they are the air flow of combustion grate left side 1-1, air flow of dry grate left side 1, temperature of primary combustion chamber, left side temperature of primary combustion chamber, right side temperature of primary combustion chamber, cumulative primary air flow, cumulative secondary air flow, accumulated urea solution flow, accumulated urea solution supply flow and NOx emission value. Among these variables, air flow is detected by the air volume sensor, the temperature is detected by the thermocouple temperature sensor, and the urea solution is detected by the liquid flowmeter.

Since the sensors works in the environment with high temperature and ash content, the original data is often accompanied by noise. To eliminate the influence of noise on prediction model, Rajda criterion is adopted to smooth and de-noise the original data. In addition, Z-score algorithm is used for normalization to eliminate the influence between different dimensions. After data processing, the processed variables and NOx value are taken as input and output of DMNN model, respectively. After off-line training of model, the real-time data in server is read online and used as inputs of DMNN model to predict NOx value of 10 s. The predicted value of NOx can be used for reference in denitration control system. If predicted value is higher than the current moment, the operator will increase the urea input to reduce NOx emission and meet the environmental protection index. On the contrary, if predicted value of NOx is lower than the current value, it is necessary to reduce urea supply to meet the economic indicators.

### Dynamic Task Decomposition Based on PCA

The original data was read from distributed control system with sampling interval of 10 s. A sliding window is used to detect the principal components in the time-series. The size of sliding window is denoted by win_1. Assume that the observation sample matrix in the first sliding window is represented by X_{M×n}_{₁}^{win_1}

$${X}_{m \times {n}_{1}}^{win \_ 1} = {[ \begin{matrix}\begin{matrix}\begin{matrix}{x}_{1} & {x}_{2}\end{matrix} & ⋯\end{matrix} & {x}_{m}\end{matrix} ]}^{T} = [ \begin{matrix}{x}_{11} & {x}_{12} & … & {x}_{1 {n}_{1}} \\ {x}_{21} & {x}_{22} & … & {x}_{2 {n}_{1}} \\ ⋮ & ⋮ & & ⋮ \\ {x}_{m 1} & {x}_{m 2} & … & {x}_{{mn}_{1}}\end{matrix} ] \qquad ( 1 )$$

where m and n₁ are the number of variables and samples in the sliding window win_1. x₁ x₂ . . . xₘ represent m variables of the matrix, which are inputs of prediction model. For the debutanizer column dataset, x₁ x₂ . . . xₘ denote a total of 13 variables, they are top temperature, top pressure, flow of reflux, flow to the next process, temperature of the sixth tray at time t, temperature of the sixth tray at t-1, temperature of the sixth tray at t-2, temperature of the sixth tray at t-3, average value of the temperature at bottom at t, and the butane concentration at t-1, t-2, t-3, and t-4, respectively. The size of m is 13 in this case. For MSWI process, x₁ x₂ . . . xₘ represent a total of 10 variables, they are air flow of combustion grate (left side 1-1), air flow of combustion grate (right side 1-1), air flow of dry grate (left side 1-1), primary combustion chamber temperature, primary combustion chamber temperature(left), primary combustion chamber temperature(right), accumulation of primary air flow, accumulation of secondary air flow, accumulation of urea solution, and accumulation of urea solvent supply, respectively. The size of m is 10 in the real industrial data.

The mean vector μ of sample matrix X_{m×n}_{₁}^{win_1} is denoted as

$$μ = {[ {\overline{μ}}_{1} , {\overline{μ}}_{2} , … , {\overline{μ}}_{m} ]}^{T} \qquad ( 2 )$$

$${\overline{μ}}_{i} = \frac{1}{{n}_{1}} {\sum }_{j = 1}^{{n}_{1}} {x}_{ij} \qquad ( 3 )$$

where μ̅₁, μ̅₂, . . . , μ̅ₘ represent mean value of each row in X_{m×n}_{₁}^{win_1}, and then the mean value of each variable can be obtained by Eq. (3). μ̅ᵢ denotes the i-th value of vector μ. i=1, 2, . . . , m, and m is the number of variables. xᵢⱼ denote the value of i-th variable in j-th sample. j=1, 2, . . . , n₁, n₁ represents samples number in sliding window with the size of win_1.

All the samples of matrix X_{m×n}_{₁}^{win_1} minus the mean (decentralized) are denoted as

$$\begin{matrix}{\tilde{X}}_{m \times {n}_{1}}^{win \_ 1} = [ \begin{matrix}{x}_{11} {x}_{12} ⋯ {x}_{1 {n}_{1}} \\ {x}_{21} {x}_{22} ⋯ {x}_{2 {n}_{1}} \\ ⋮ \\ {x}_{m 1} {x}_{m 2} ⋯ {x}_{{mn}_{1}}\end{matrix} ] - [ \begin{matrix}{\overline{μ}}_{1} , {\overline{μ}}_{1} , … , {\overline{μ}}_{1} \\ {\overline{μ}}_{2} , {\overline{μ}}_{2} , ⋯ , {\overline{μ}}_{2} \\ ⋮ \\ {μ}_{m} , {\overline{μ}}_{m} , ⋯ , {\overline{μ}}_{m}\end{matrix} ] \\ = [ \begin{matrix}{\tilde{x}}_{11} {\tilde{x}}_{12} ⋯ {\tilde{x}}_{1 {n}_{1}} \\ {\tilde{x}}_{21} {\tilde{x}}_{22} ⋯ {\tilde{x}}_{2 {n}_{1}} \\ ⋮ \\ {\tilde{x}}_{m 1} {\tilde{x}}_{m 2} ⋯ {\tilde{x}}_{{mn}_{1}}\end{matrix} ] \\ = {[ {\tilde{x}}_{1} , {\tilde{x}}_{2} , … , {\tilde{x}}_{m} ]}^{T}\end{matrix} \qquad ( 4 )$$

where \tilde{X}_{m×n}_{₁}^{win_1} represents the matrix after decentralization, \tilde{x}ᵢⱼ denotes the value of the i-th feature after decentralization in j-th sample, m represents the number of variables, and n is the number of samples contained in sliding window with the size of win_1.

The covariance matrix H_{m×m}^{win_1} of \tilde{X}_{m×n}_{₁}^{win_1} is calculated as:

$${H}_{m \times m}^{win \_ 1} = \frac{1}{{n}_{1} - 1} {\tilde{X}}_{m \times {n}_{1}}^{win \_ 1} \cdot {\tilde{X}}_{m \times {n}_{1}}^{win \_ 1 T} \qquad ( 5 )$$

where \tilde{X}_{m×n}_{₁}^{win_1T} is the transpose of \tilde{X}_{m×n}_{₁}^{win_1}.

Then, the eigenvalue λ of covariance matrix H_{m×m}^{win_1} can be calculated as

$$\vert {H}_{m \times m}^{win \_ 1} - λ I \vert = 0 \qquad ( 6 )$$

$$I = [ \begin{matrix}1 & 0 & ⋯ & 0 \\ 0 & 1 & ⋯ & 0 \\ ⋮ & & & \\ 0 & 0 & ⋯ & 1\end{matrix} ] \qquad ( 7 )$$

where I denote the unit matrix. Based on Eq. (6), the eigenvalues of H_{m×m}^{win_1} can be represented as

λ₁≥λ₂≥ . . . ≥λ_{Q} (8)
where Q is the number of eigenvalues. According to Eq. (8), the eigenvector α corresponding to each eigenvalue is calculated as

(H_{m×m}^{win_1}−λₖI)αₖ=0 (9)
where H_{m×m}^{win_1} is covariance matrix. λₖ denotes the k-th eigenvalue. I is unit matrix, which is represented by Eq. (7). αₖ is eigenvector corresponding to the k-th eigenvalue. αₖ=[α₁ₖ, α₂ₖ, . . . , αₘₖ]^{T}, (k=1, 2, . . . , Q).

The threshold of cumulative variance contribution rate is set as θ, and if the cumulative variance satisfies

$${\sum }_{i = 1}^{{Q}_{0}} {λ}_{k} > θ \qquad ( 10 )$$

Then the first Q₀ principal components are selected for further analysis. Q₀ is the number of principal components, which is determined by Eq. (10). The number of eigenvalues is Q₀, which is equal to the number of principal components. λₖ denotes the k-th eigenvalues.

Generally, in most studies, the threshold of cumulative variance contribution rate is selected above 0.8, that is, θ≥0.8. Therefore, the threshold θ is determined as 0.85.

Then, the unit eigenvector α corresponding to Q₀ eigenvalues is used as a coefficient for linear transformation to obtain Q₀ principal components.

zₖ=αₖ^{T}x (11)
where αₖ=[α₁ₖ, α₂ₖ, . . . , αₘₖ]^{T} (k=1, 2, . . . , Q₀).

Combining with the samples in X_{m×n}_{₁}^{win_1}, the principal components of n₁ samples can be obtained by Eq. (11). The k-th principal component zₖⱼ of the j-th sample xⱼ=[x₁ⱼ, x₂ⱼ, . . . , xₘⱼ]^{T} (j=1, 2, . . . , is calculated as

$$\begin{matrix}{𝓏}_{kj} = {[ {α}_{1 k} , {α}_{2 k} , … , {α}_{m k} ] [ {x}_{1 j} , {x}_{2 j} , {x}_{mj} ]}^{T} \\ = {\sum }_{i = 1}^{m} {α}_{ik} {x}_{ij}\end{matrix} \qquad ( 12 )$$

where α₁ₖ, α₂ₖ, . . . , αₘₖ denoted the m values of k-th unit eigenvector. x₁ⱼ, x₂ⱼ, . . . , xₘⱼ represent the m variables of j-th sample, respectively. j=1, 2, . . . , n₁, i=1, 2, . . . , m, and k=1, 2, . . . , Q₀.

According to Eq. (12), zₖ that containing k principal components can be denoted by zₖ=[zₖ₁, zₖ₂, . . . , zₖₙ_{₁}]. Therefore, a factor load is defined as the correlation between the k-th principal component zₖ and i-th feature xᵢ, which is calculated as

$$ρ ( {𝓏}_{k} , {x}_{i} ) = \frac{\sqrt{{λ}_{k}} {α}_{ik}}{\sqrt{{σ}_{ii}}} \qquad ( 13 )$$

where αᵢₖ is the unit eigenvector, which denote the i-th value in αᵢₖ. σᵢᵢ is the variance of the i-th variable xᵢ, which is also the i-th diagonal entry of covariance matrix H_{m×m}^{win_1}, k=1, 2, . . . , Q₀, i=1, 2, . . . , m. The factor load matrix is expressed as

$$ρ = [ \begin{matrix}ρ ( {𝓏}_{1} , {x}_{1} ) & ρ ( {𝓏}_{1} , {x}_{2} ) & … & ρ ( {𝓏}_{1} , {x}_{m} ) \\ ρ ( {𝓏}_{2} , {x}_{1} ) & ρ ( {𝓏}_{2} , {x}_{2} ) & … & ρ ( {𝓏}_{2} , {x}_{m} ) \\ & ⋮ & & \\ ρ ( {𝓏}_{q} , {x}_{1} ) & ρ ( {𝓏}_{q} , {x}_{2} ) & … & ρ ( {𝓏}_{q} , {x}_{m} )\end{matrix} ] \qquad ( 14 )$$

Then, the contribution rate υᵢ of Q₀ principal components to the i-th variable xᵢ(i=1, 2, . . . , m) is

$${υ}_{i} = {\sum }_{k = 1}^{{Q}_{0}} {ρ}^{2} ( {𝓏}_{k} , {x}_{i} ) \qquad ( 15 )$$

where the contribution rate υᵢ is the sum of squares of factor loads between the Q₀ principal components and i-th variable xᵢ. Then, the contribution rate matrix υ of Q₀ principal components corresponding to each variable can be expressed as

υ=[υ₁, υ₂, . . . , υₘ] (16)
where m represents the number of variables contained in X_{m×n}_{₁}^{win_1}. The importance of variables changes with the fluctuation of complex operating conditions in MSWI furnace, that is, the contribution rate υᵢ of principal components corresponding to each variable will also change. Therefore, the contribution rate υ is reordered in a descending order.

sort(υ)=[υₘₐₓ, . . . , υₘᵢₙ] (17)
where the function of sort(·) is to sort data in a descending order. υₘₐₓ and υₘᵢₙ represent the maximum and minimum value of contribution rate, respectively. The key variables are determined by defining a threshold value ψ.

$$\{ {\sum }_{i = 1}^{F} {υ}_{i} \} > ψ \qquad ( 18 )$$

where the value of ψ is equal to the cumulative variance contribution rate, that is ψ=0.85. F denote the number of key variables, which can be determined by ψ. Equation (18) indicates that the first F variables have the greatest correlation with the principal components in the current window. Then, the first F key features are selected as reference vectors for condition identification, as shown in Eq. (19).

con_1=[x_{num_1}^{win_1}, x_{num_2}^{win_1}, . . . , x_{num_F}^{win_1}] (19)
where x_{num_1}^{win_1}, x_{num_2}^{win_1}, . . . , x_{num_F}^{win_1} represent the first F variables in X_{m×n}_{₁}^{win_1}. Thereafter, the window moves forward by a certain step, and the key variables are detected successively. Finally, the key variables in each sub-task are stored in the knowledge base for modeling analysis, which is expressed as

condition_library=[con_1,con_2, . . . , con_W] (20)
where con_1,con_2, . . . , con_W represent reference vectors corresponding to different operating conditions, respectively. W denotes the number of operating conditions.

In this invention, the size of sliding window and moving step is selected according to specific data sets. The simulation phase includes a debutanizer column process and a real industrial data of MSWI process. For debutanizer column process, the sliding window size is 600. Considering the dataset is accompanied by slow fluctuations, the moving step of sliding window is set to 300. For MSWI process, the size of sliding window is 600. Considering the complex variation and large fluctuation of the process, the moving step of sliding window is set to 100.

### Construction of the LSTM-Based Sub-Network

The performance of sub-network is critical for the whole MNN. Aiming each sub-task, LSTM neural network is explored driven by the corresponding key variables. LSTM cell comprises forget, input, cell state and output gate, which can effectively overcome the gradient disappearance problem existing in general networks through the gate operation.

The internal structural of LSTM cell is shown in FIG. 3. Different gates are marked with different colors. Each gate is calculated as follows

Forget gate:

fₜ=σ(W_{f}·[hₜ₋₁, xₜ]+b_{f}) (21)

Input gate:

iₜ=σ(Wᵢ·[hₜ₋₁, xₜ]+bₜ) (22)

Cell state gate:

\tilde{C}ₜ=tan h(W_{c}·[hₜ₋₁, xₜ]+b_{c}) (23)

Cₜ=fₜ⊗Cₜ₋₁+iₜ⊗\tilde{C}ₜ (24)

Output gate:

oₜ=σ(Wₒ[hₜ₋₁, xₜ]+bₒ) (25)

Using Eqs. (21)-(25), the final output of LSTM is

ŷ_{NOx}^{t}=oₜ⊗tan h(Cₜ) (26)
where xₜ denote the input of LSTM neural network at time t. They are air flow of combustion grate (left side 1-1), air flow of combustion grate (right side 1-1), air flow of dry grate (left side 1-1), primary combustion chamber temperature, primary combustion chamber temperature(left), primary combustion chamber temperature(right), accumulation of primary air flow, accumulation of secondary air flow, accumulation of urea solution, accumulation of urea solvent supply at time t, respectively. hₜ₋₁ is the output of LSTM neural network at time t-1. W_{f}, Wᵢ, W_{c} and Wₒ denote the weight matrix of the forget, input, cell state and output gate, respectively. b_{f}, bᵢ, b_{c} and bₒ are the bias of the forget, input, cell state and output gate, respectively. fₜ, iₜ, Cₜ and oₜ represent the output of the forget, input, cell state and output gate, respectively. ŷ_{NOx}^{t} is the output of LSTM neural network at time t. σ(·) and tan h(·) are the activation functions, which are calculated as

$$σ ( U ) = \frac{1}{1 + {e}^{- U}} \qquad ( 27 )$$

$$tanh ( U ) = \frac{{e}^{U} - {e}^{- U}}{{e}^{U} + {e}^{- U}} \qquad ( 28 )$$

where U denote the input of activation function in each gate.

Forget gate:

U_{f}=W_{f}·[hₜ₋₁, xₜ]+b_{f} (29)

Input gate:

Uᵢ=Wᵢ·[hₜ₋₁, xₜ]+bᵢ (30)

Cell state gate:

U_{c}=W_{c}·[hₜ₋₁, xₜ]+b_{c} (31)

Output gate:

Uₒ=Wₒ·[hₜ₋₁, xₜ]+bₒ (32)

### Cooperation Decision Strategy

During testing stage, the similarity between the i-th testing sample and training samples is measured by Euclidean distance.

d_{g,j}^{test}=dist(x_{g}^{test}, xⱼ^{train}), (j=1, 2, . . . , N) (33)

dist(x_{g}^{test}, xⱼ^{train})=\sqrt{∥x_{g}^{test_1}−xⱼ^{train_1}∥²+ . . . +∥x_{g}^{test_m}−xⱼ^{train_m}∥²} (34)

d_{g}^{test}=[d_{g,1}^{test}, d_{g,2}^{test}, . . . , d_{g,N}^{test}] (35)
where x_{g}^{test} is the g-th sample of testing set. x_{g}^{test_1} and x_{g}^{test_m} denote the first and m-th variable of g-th testing sample, respectively. Similarly, xⱼ^{train_1} and xⱼ^{train_m} denote the first and m-th variable of j-th training sample, respectively. d_{g,1}^{test}, d_{g,2}^{test}, . . . , d_{g,N}^{test} represent Euclidean distance between g-th sample of testing set and samples of training set, respectively. g=1, 2, . . . , G, j=1, 2, . . . , N. N and G denote the number of samples in training and testing sets.

According to Eq. (35), the training sample xⱼ^{train} which is closest to testing sample x_{g}^{test} is selected. Then, the operating condition of x_{g}^{test} is determined by that of xⱼ^{train}.

Finally, a decision operation strategy is adopted to generate the prediction outputs of MNN during testing phase, which are calculated as

$${\hat{y}}_{N O x} = \frac{{\sum }_{r = 1}^{R} {\hat{y}}_{N O x}^{r}}{R} \qquad ( 36 )$$

where ŷ_{NOx} denote the predicted value of NOx emission, and ŷ_{NOx}^{r} is the output of sub-network. r=1, 2, . . . , R, R represent the number of activated sub-networks.

### DMNN-Based Prediction Model

The NOx emission prediction model for MSWI process based on DMNN mainly includes four parts: data preprocessing, PCA-based dynamic task decomposition, construction of sub-network and cooperation decision strategy. As shown in FIG. 4, the original dataset is represented by X^{ori}, and X^{ori}ϵR^{L×m}, where L denotes the number of samples and m is the number of variables. First, the original data is preprocessed via smooth and normalization, and then represented by X^{pre}={x₁ⁱ, x₂ⁱ, . . . , xₘⁱ, y_{NOx}ⁱ}ᵢ₌₁^{N}. Second, to implement a dynamic task decomposition, a sliding window is performed on the training set to determine key variables. Furthermore, the corresponding sub-task is formed in each window. Then, a LSTM-based sub-network is established for sub-task with different key variables as inputs. During the testing phase, the sub-networks are activated using similarity between the testing and the training samples, which is measured via Euclidean distance. And the cooperative decision strategy is used to integrate each activated sub-network to generate the final prediction results of NOx.

### Data Preprocessing

Denoising: In MSWI process, the sensors usually operate in a high temperature and dust environment, which bring the noise to original data. To reduce the effect of the noise on data analysis, Rajda is used to smooth the original data, as shown in Eq. (37).

|x^{ori}−μ^{ori}|≥3Σ^{ori} (37)
where x^{ori} denotes original sample, μ^{ori} and σ^{ori} denotes the mean and standard deviation of variables, respectively. The samples satisfying Eq. (37) are regarded as the outliers and removed from the original data. Then, the dataset after smoothing is expressed as X^{smo}, X^{smo}ϵR^{N×m}. N and m denote the number of samples and variables, respectively.

Normalization: To eliminate the influence of different dimensions among the variables and improve the prediction accuracy, standardization is performed on the dataset using Z-score method, which is calculated as Eq. (38).

$${x}_{i} = \frac{{x}_{i}^{s m o} - {μ}_{i}^{s m o}}{{σ}_{i}^{s m o}} \qquad ( 38 )$$

where xᵢ, μᵢ^{smo}, and σᵢ^{smo} (i=1, 2, . . . , m) are the normalized vector, mean and standard deviation of the i-th dimension variable, respectively. The normalized dataset is represented by X_{N×m}^{T}. N and m denote the number of samples and variables, respectively.

### Schematic Diagram of DMNN-Based Prediction Model

In this section, the proposed DMNN-based NOx emission prediction framework for MSWI process (as shown in FIG. 4) is described as follows.

### Training Phase

Step 1: Preprocess the original data ori_data=[X^{ori} Y^{ori}] based on Eqs. (37), (38), and then the dataset is expressed by dataset=[X Y];

Step 2: Set a sliding window with a fixed length of win, and the subset contained in the window is X^{win_1}; The key features of X^{win_1} are constructed by Eqs. (1)-(20); Thereafter, the window moves forward by a certain step, and the key variables are detected successively; Finally, the key variables in each sub-task are stored in the knowledge base for modeling analysis;

Step 3: For each sub-task, LSTM is applied to established the sub-network driven by the corresponding key variables. And the number of hidden neurons is optimized by trial-and-error method;

Step 4: Move the sliding window in steps and repeat step 2)-step 3).

### Testing Phase

Step 5: Calculate the similarity between the test sample and training samples via Eqs. (33)-(35) and generate the outputs of MNN by activating the corresponding the sub-networks.

Step 6: The final prediction result of NOx emission is obtained by integrating the outputs of the sub-networks with a cooperation decision strategy by Eq. (36).

To evaluate the effectiveness of the proposed method, the merits of the DMNN are confirmed on a debutanizer column process and real industrial data of a MSWI process. All the simulations were carried out using MATLAB_R2019b.lnk on a PC with Intel® Core™ i7-7700, CPU @ 3.60 GHz and RAM 8.00 GB. Furthermore, the performances of DMNN was measured by calculating the root mean square error (RMSE), mean absolute percentage error (MAPE), and r-square (R²).

$$R M S E = \sqrt{\frac{1}{N} {\sum }_{j = 1}^{N} {( {y}_{d \_ j}^{NOx} - {y}_{o \_ j}^{NOx} )}^{2}} \qquad ( 39 )$$

$$M A P E = \frac{100 \%}{N} {\sum }_{j = 1}^{N} \vert \frac{{y}_{d \_ j}^{NOx} - {y}_{o \_ j}^{NOx}}{{y}_{o \_ j}^{NOx}} \vert \qquad ( 40 )$$

$${R}^{2} = 1 - \frac{{\sum }_{j = 1}^{N} {( {y}_{o \_ j}^{NOx} - {y}_{d \_ j}^{NOx} )}^{2}}{{\sum }_{j = 1}^{N} {( {y}_{o \_ j}^{NOx} - {\overline{y}}_{o}^{NOx} )}^{2}} \qquad ( 41 )$$

where y_{d_j}^{NOx}, y_{o_j}^{NOx} and y̅ₒ^{NOx} denote the desired, predicted and mean outputs of NOx, respectively.

### BRIEF DESCRIPTION OF THE DRAWINGS

FIG. 1 is a Hardware system in MSWI process.

FIG. 2 is a Flow chart of MSWI process.

FIG. 3 is a Structure of LSTM neural cell.

FIG. 4 is a DMNN-based model for NOx emission prediction in MSWI process.

FIG. 5 is a Distribution of variable importance.

FIG. 6 is a Training result of DMNN.

FIG. 7 is a Testing result of DMNN.

FIG. 8 is a Regression analysis.

FIG. 9 is a Prediction errors comparison of different algorithms.

FIGS. 10a-10e are Prediction errors distribution of different algorithms.

FIG. 11 is a Distribution of variable importance.

FIG. 12 is a Training result of DMNN.

FIG. 13 is a Testing result of DMNN.

FIG. 14 is a Regression analysis.

FIG. 15 is a Prediction errors comparison of different algorithms.

FIGS. 16a-16e are Prediction errors distribution of different algorithms.

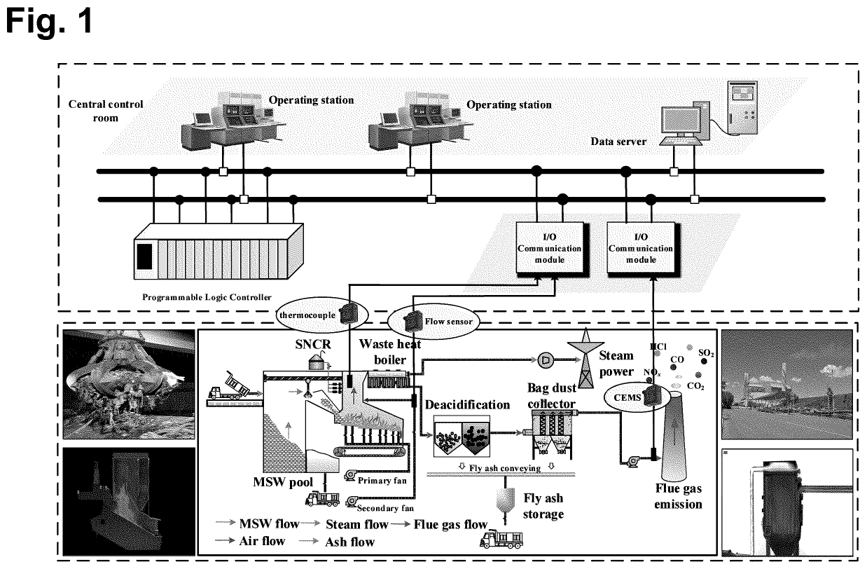

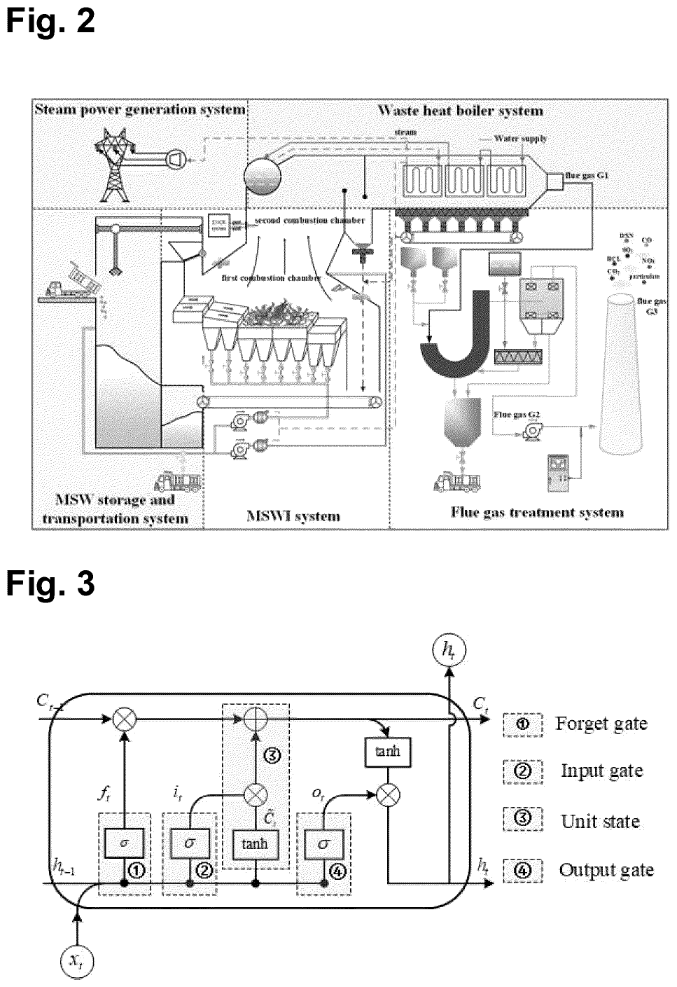

### DETAILED DESCRIPTION

This invention firstly uses the debutanizer column process to verify the validity of DMNN method, and then it was applied on a real MSWI process to predict NOx emission concentration.

### C4 Prediction Based on the DMNN

The original dataset is composed of 2394 samples with 7 variables. Table 1 gives a detailed description of these variables. Considering the dynamic characteristics in the real process, a set of optimal variables were selected for C4 prediction, as shown in Eq. (42).

$${[ \begin{matrix}{u}_{1} ( t ) , {u}_{2} ( t ) , {u}_{3} ( t ) , {u}_{4} ( t ) , {u}_{5} ( t ) , {u}_{5} ( t - 1 ) , \\ {u}_{5} ( t - 2 ) , {u}_{5} ( t - 3 ) , ( {u}_{6} ( t ) + {u}_{7} ( t ) ) / 2 , \\ y ( t - 1 ) , y ( t - 2 ) , y ( t - 3 ) , y ( t - 4 )\end{matrix} ]}^{T} \qquad ( 42 )$$

TABLE 1
Variable description on debutanizer column

| Secondary variables | Description |
|---|---|
| u₁ | Top temperature |
| u₂ | Top pressure |
| u₃ | Flow of reflux |
| u₄ | Flow to the next process |
| u₅ | Temperature of the sixth tray |
| u₆ | Temperature A at bottom |
| u₇ | Temperature B at bottom |

The dataset was divided into training and testing set at a ratio of 7:3. The length and step of sliding window is 600 and 300, respectively.

### Dynamic Task Decomposition Based on PCA

To explore the dynamics in different windows, a total of five sub-tasks are obtained via the dynamic task decomposition based on PCA. The variable importance in each sub-task is shown in FIG. 5.

The results in FIG. 5 illustrate that the distribution of variable importance in each sub-task is different. It can be seen that the dynamic operation characteristics can be described by the variable importance due to the different distribution of samples in each window. To further visualize the importance of each variable, the variables are sorted in descending order according to the cumulative contribution rate, as shown in Table 2.

TABLE 2
Sorting results of variables in different windows

| Window | | | | | | | | | | | | | |
|---|---|---|---|---|---|---|---|---|---|---|---|---|---|
| number | Order of variables (In descending order of contribution rate) | | | | | | | | | | | | |
| win_1 | x₂ | x₁ | x₆ | x₇ | x₉ | x₃ | x₅ | x₈ | x₁₂ | x₁₃ | x₁₀ | x₄ | x₁₁ |
| win_2 | x₃ | x₆ | x₇ | x₂ | x₄ | x₉ | x₅ | x₁ | x₈ | x₁₃ | x₁₂ | x₁₁ | x₁₀ |
| win_3 | x₂ | x₁ | x₃ | x₆ | x₇ | x₉ | x₅ | x₄ | x₈ | x₁₃ | x₁₂ | x₁₀ | x₁₁ |
| win_4 | x₂ | x₁ | x₃ | x₆ | x₇ | x₄ | x₅ | x₉ | x₁₀ | x₁₃ | x₈ | x₁₂ | x₁₁ |
| win_5 | x₂ | x₁ | x₆ | x₃ | x₄ | x₇ | x₉ | x₅ | x₈ | x₁₁ | x₁₃ | x₁₂ | x₁₀ |

Table 2 shows that the distribution of variables is different, which can be used to characterize different operation conditions. The cumulative contribution rate threshold is determined as ζ=0.85, Then, the variables with the cumulative contribution rate higher than ζ is regarded as the key variables for each sub-task.

### C4 Prediction Based on DMNN

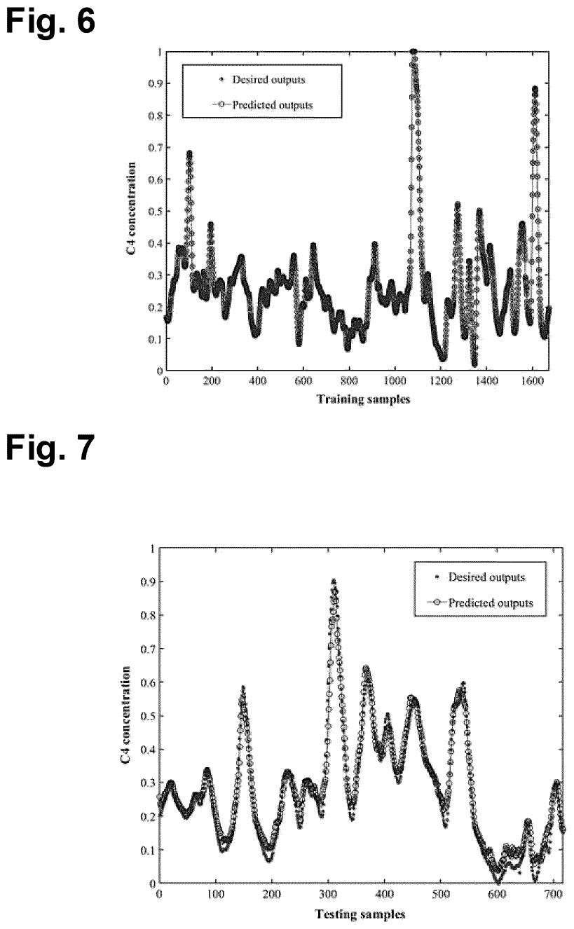

Aiming each sub-task, LSTM is used to established the sub-network driven by the key variables. The training and testing results of C4 prediction for debutanizer column are shown in FIG. 6, 7, which demonstrated that the proposed DMNN has the superior performance in terms of its approximation capability.

To demonstrate the merits of the proposed method, the performance of DMNN is compared with those of RBF, LSSVM, DBN and LSTM methods, as shown in Table 3.

TABLE 3
Comparison of C4 prediction results on debutanizer column

| | Training phase | | | Testing phase | | |
|---|---|---|---|---|---|---|
| Methods | RMSE | MAPE | R² | RMSE | MAPE | R² |
| RBF | 0.0202 | 0.0789 | 0.9816 | 0.1575 | 0.3982 | 0.2316 |
| LSSVM | 0.0154 | 0.0581 | 0.9893 | 0.0538 | 0.1479 | 0.9105 |
| DBN | — | — | — | 0.1655 | 1.8736 | — |
| LSTM | — | — | — | 0.0736 | 0.8566 | — |
| DMNN | 0.0057 | 0.0215 | 0.9986 | 0.0311 | 0.1343 | 0.9701 |

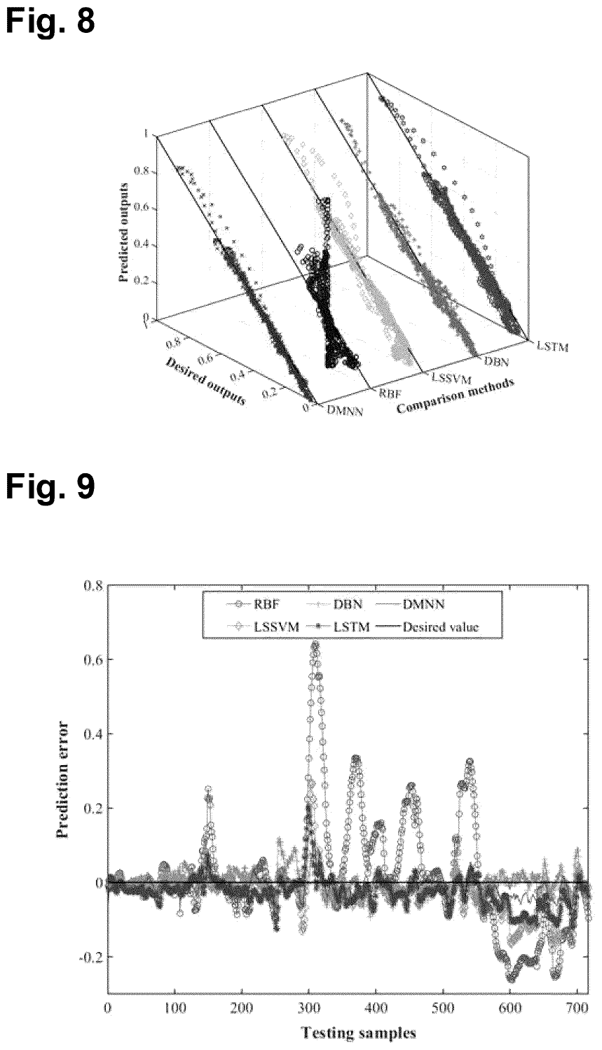

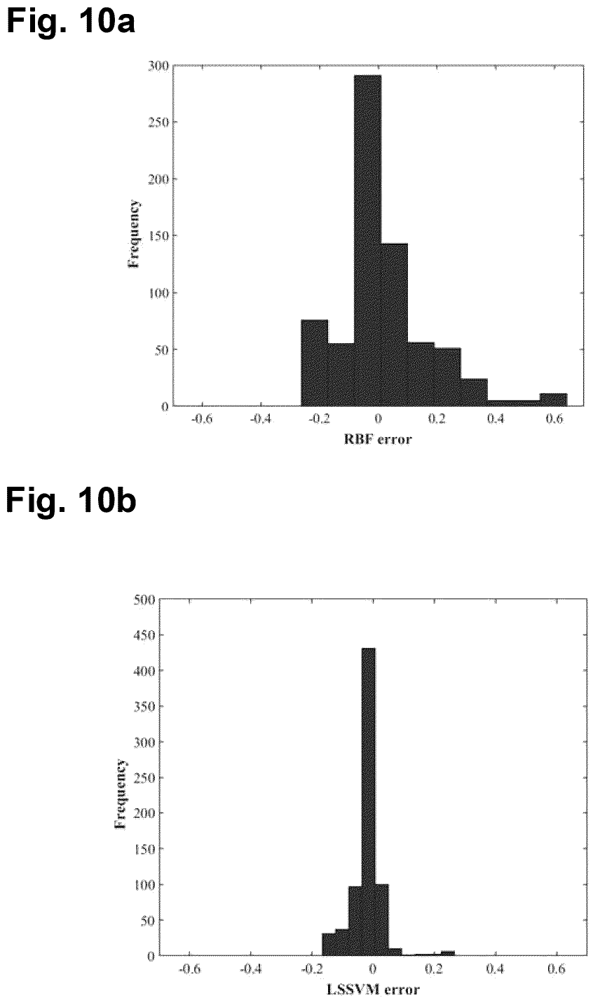

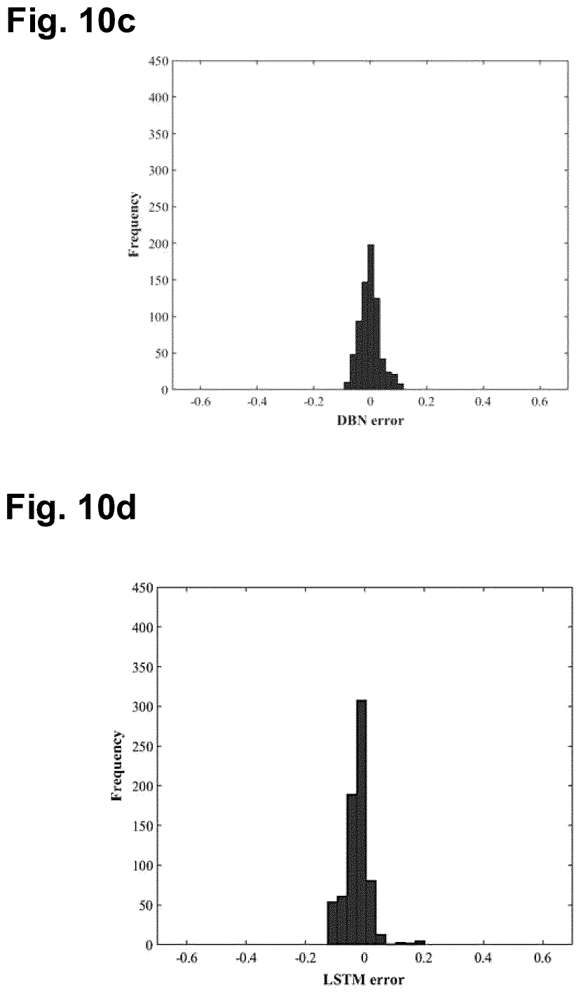

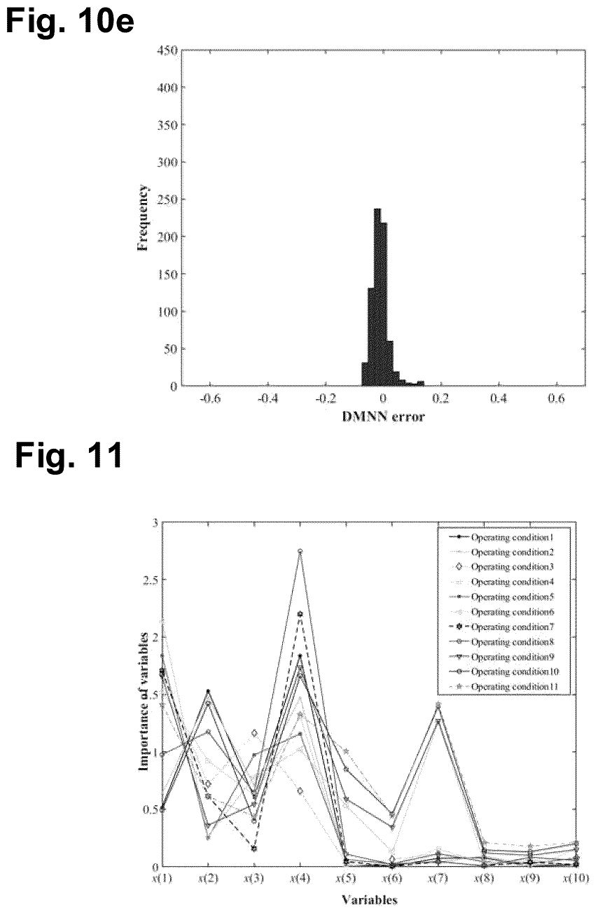

Compared with RBF, LSSVM and DBN, LSTM neural network shows significant advantages in terms of its lower RMSE, MAPE and R². It illustrates that LSTM is more suitable to tackle the complex task because of its memory properties. On this basis, PCA-based dynamic task decomposition method further improves the prediction accuracy of C4. In contrast with other methods, DMNN shows an average improvement of 65.35% in RMSE, 68.48% in MAPE, and 39.91% in R². Besides, the regression performance of different methods plotted in FIG. 8 reveals the high approximation ability of the proposed DMNN.

For performance comparison, the prediction errors of each method are visualized in FIG. 9, 10a-10e. Compared with the other methods, the prediction error of the DMNN is significantly closer to 0, which indicates the effectiveness of this method.

### Prediction of NOx Emission in MSWI Process

MSWI process is a complex dynamic system. As one of the important pollutant, accurate prediction of NOx emission has great significance to ensure the stable operation of MSWI plant. The experiment was implemented based on the real industrial data. A total of 2215 samples was collected from the DCS with the sampling interval of 10 s. 1550 samples are considered as the training set to construct the model, and the remaining are used to evaluate the proposed method. Combined with the operation characteristic of MSWI process, 10 variables that are highly related to NOx are used for establishing the prediction model, as shown in Table 4.

TABLE 4
Variable description of NOx prediction model.

| Index | Variables | Range | Unit |
|---|---|---|---|
| 1 | Air flow of combustion grate (left side 1-1) | 4~13 | km³N/h |
| 2 | Air flow of combustion grate (right side 1-1) | 5.5~10 | km³N/h |
| 3 | Air flow of dry grate (left side 1-1) | 1~5 | km³N/h |
| 4 | Primary combustion chamber temperature | 900~1040 | ° C. |
| 5 | Primary combustion chamber temperature(left) | 870~1070 | ° C. |
| 6 | Primary combustion chamber temperature(right) | 850~1050 | ° C. |
| 7 | Accumulation of primary air flow | 980~1383 | km³N |
| 8 | Accumulation of secondary air flow | 55~95 | km³N |
| 9 | Accumulation of urea solution | 1370~1876 | L |
| 10 | Accumulation of urea solvent supply | 3.31(*10⁴) ~ 3.37(*10⁴) | L |

In this section, the length of sliding window is 600. Considering the frequent changes of MSWI process, the moving step of the window is 100.

### Dynamic Task Decomposition Based on PCA

A total of 11 sub-tasks are obtained using the dynamic task composition method. The variables importance in each window are shown in FIG. 11.

FIG. 11 reveals that the distribution of variables importance is different in each sub-tasks, which is closely related to the characteristic of real MSWI process. Influenced by the feed quantity, composition and operation means, MSWI process is complex and fluctuant. Thus, the principal components have different contribution rates to each variable. According to the ζ=0.85, the dominant variables are determined for each sub-task, as shown in Table 5.

TABLE 5
Sorting results of variables in different windows

| Window | | | | | | | | | | |
|---|---|---|---|---|---|---|---|---|---|---|
| number | Order of variables (In descending order of contribution rate) number | | | | | | | | | |
| win_1 | x₄ | x₂ | x₃ | x₁ | x₈ | x₇ | x₁₀ | x₅ | x₆ | x₉ |
| win_2 | x₂ | x₄ | x₃ | x₁ | x₈ | x₇ | x₆ | x₁₀ | x₉ | x₅ |
| win_3 | x₁ | x₃ | x₂ | x₄ | x₇ | x₁₀ | x₈ | x₆ | x₅ | x₉ |
| win_4 | x₁ | x₄ | x₂ | x₃ | x₇ | x₁₀ | x₈ | x₆ | x₅ | x₉ |
| win_5 | x₁ | x₄ | x₃ | x₂ | x₇ | x₁₀ | x₅ | x₈ | x₉ | x₆ |
| win_6 | x₁ | x₇ | x₄ | x₃ | x₅ | x₂ | x₆ | x₉ | x₈ | x₁₀ |
| win_7 | x₄ | x₁ | x₂ | x₃ | x₅ | x₇ | x₉ | x₁₀ | x₈ | x₆ |
| win_8 | x₄ | x₂ | x₁ | x₃ | x₅ | x₉ | x₁₀ | x₇ | x₆ | x₈ |
| win_9 | x₄ | x₁ | x₇ | x₅ | x₃ | x₂ | x₆ | x₁₀ | x₈ | x₉ |
| win_10 | x₄ | x₂ | x₇ | x₅ | x₁ | x₆ | x₃ | x₁₀ | x₈ | x₉ |
| win_11 | x₇ | x₁ | x₄ | x₅ | x₂ | x₆ | x₃ | x₁₀ | x₈ | x₉ |

As can be seen from Table 5, the air flow of combustion grate and the primary combustion chamber temperature play a key role in sub-task-1, 2, 6-11 which indicates that the oxygen and temperature have an important impact for NOx emission. Besides, for the sub-tasks-3-5, the accumulation of urea solution is also an essential factor that cannot be ignored. From the analysis of NOx generation and emission mechanism, the coupling relationship between these variables and NOx is different in each sub-task.

### NOx Emission Prediction Based on the DMNN

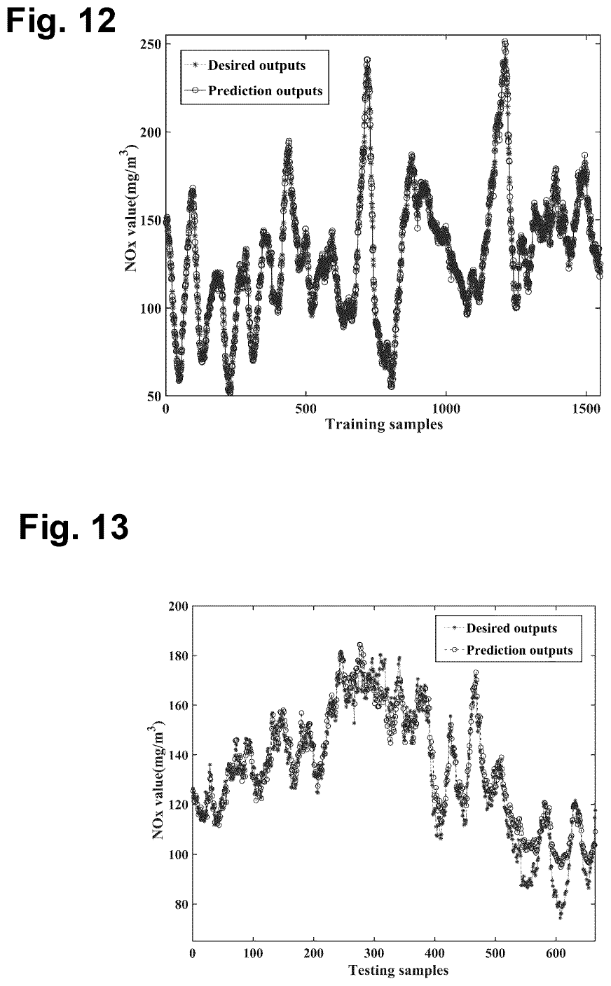

In this section, each sub-task is assigned to develop the corresponding sub-network using LSTM. The training and testing results of NOx emission prediction based on DMNN are shown in FIG. 12, 13. The results demonstrate that the predicted values of DMNN are close to the real values in general. Meanwhile, the testing results of the samples distributed in the range of 550˜650 have a large deviation, which can be explained by the violent and frequent fluctuation of the MSWI process. To further demonstrate the merits of the proposed method, the performance of DMNN is compared with those of RBF, LSSVM, DBN and LSTM neural networks, as shown in Table 6.

TABLE 6
Comparison of NOx emission prediction results on MSWI process

| | Training phase | | | Testing phase | | |
|---|---|---|---|---|---|---|
| Methods | RMSE | MAPE | R² | RMSE | MAPE | R² |
| RBF | 6.2630 | 4.0806 | 0.9696 | 12.3938 | 6.8560 | 0.7659 |
| LSSVM | 4.2520 | 2.5481 | 0.9860 | 10.4851 | 6.9292 | 0.8325 |
| DBN | 4.8278 | 2.9096 | 0.9819 | 8.0834 | 5.9306 | 0.9004 |
| LSTM | 4.0860 | 2.5801 | 0.9871 | 8.3332 | 5.0864 | 0.8942 |
| DMNN | 3.4603 | 2.0801 | 0.9890 | 7.3510 | 4.4921 | 0.9177 |

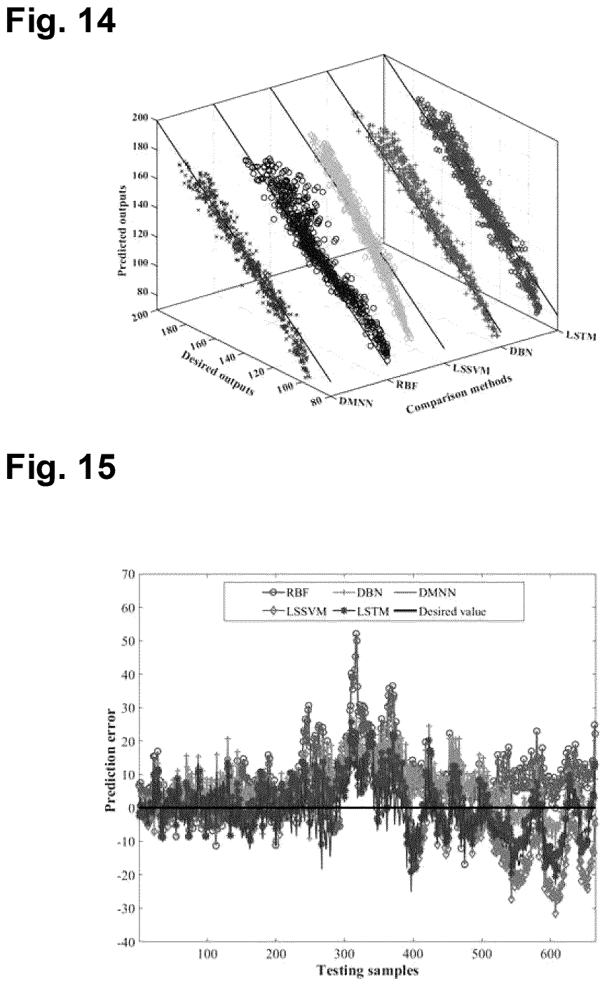

Table 6 presents the performance comparison of various methods for NOx emission prediction, wherein the effectiveness of the proposed DMNN is further manifested. Typically, LSTM neural network still shows significant advantages in processing time-series. In addition, the DMNN with dynamic task decomposition method based on PCA further improves the prediction accuracy in both the training and testing phase. Compared with other algorithms, the testing performance of the proposed method is improved by 23.25% (RMSE), 26.4%(MAPE), and 8.65 (R²) on average. FIG. 14 shows the regression performance of the various methods. Evidently, the prediction outputs of DMNN satisfactorily fit the desired outputs.

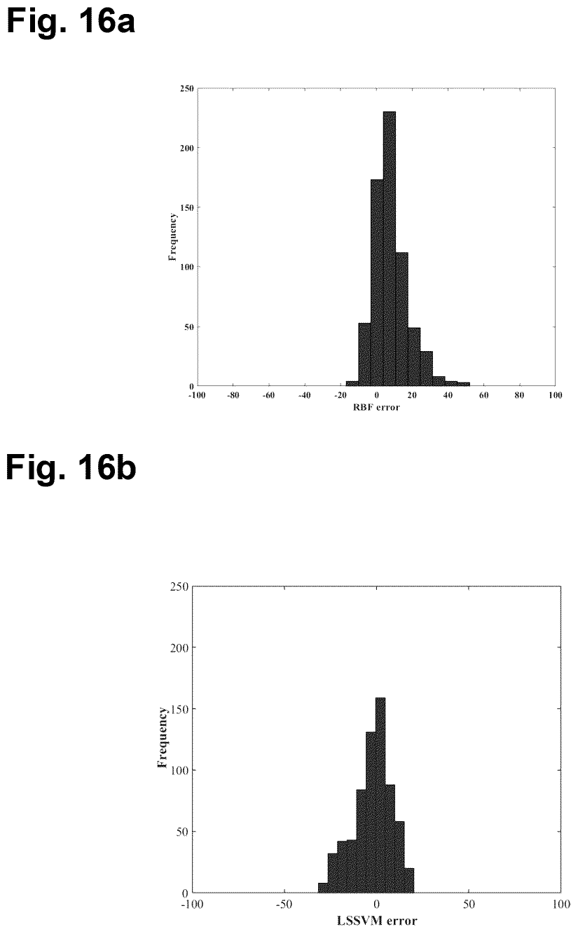

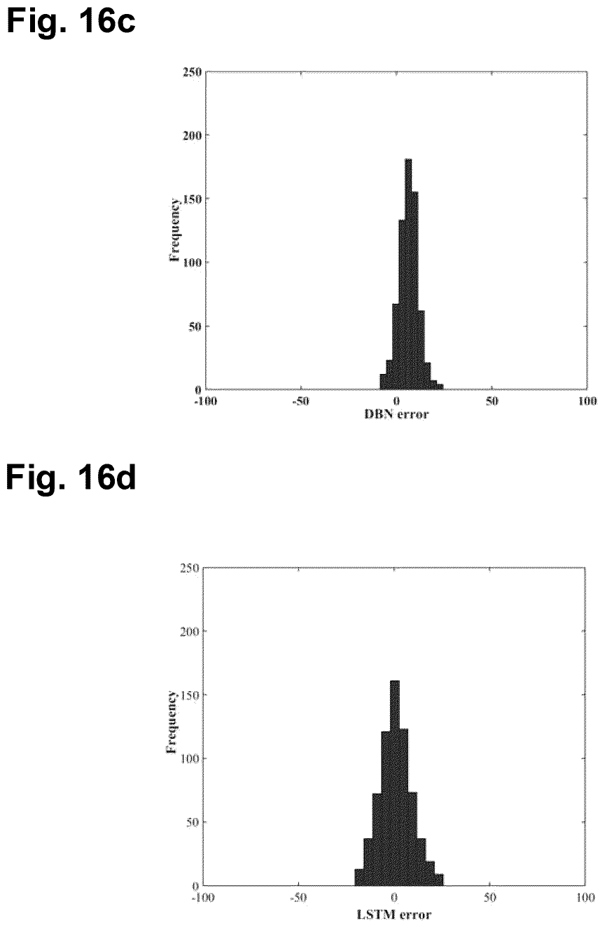

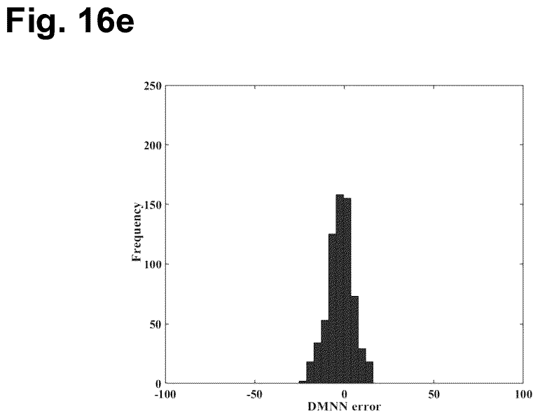

Accordingly, the prediction errors of the different methods in the testing phase are plotted in FIGS. 15 and 16a-16e, which clearly illustrates that most prediction errors of the proposed method were close to 0.

The reasonability and effectiveness of proposed DMNN were evaluated through an industrial benchmark, and it was then applied for NOx emission prediction in the MSWI process. The following advantages can be summarized based on the above analysis:

(1) A PCA-based dynamic task decomposition method: Different from traditional clustering methods, the proposed method was designed to detected the key variables in each sliding window. Then, the original task with complex dynamics was divided into several sub-tasks, thus simplifying the complexity of the task to be processed.

(2) A DMNN-based prediction model for NOx emission: Aiming each sub-task, a LSTM was constructed driven by the key variables. Then, the nonlinearity between the key variables and NOx value is learned to guarantee the prediction accuracy. Table 3 and Table 6 show the performance index of various algorithm. The experimental results demonstrated the higher generalization of DMNN via RMSEs, MAPEs and R²s on both the training and testing sets.

The technical scheme and steps above can also be described as follows:

Step 1: Dynamic task decomposition based on PCA;

Aiming to detect the dynamic operating conditions, a sliding window with fixed size was used to decompose complex task; Then, the characteristic of operating conditions can be represented by key variables in sliding window;

The algorithm is described as follows:

A sliding window is used to detect the principal components in the time-series; The size of sliding window is denoted by win_1; Assume that the observation sample matrix in the first sliding window is represented by X_{m×n}_{₁}^{win_1}

$${X}_{m \times n}^{win \_ 1} = {[ \begin{matrix}{x}_{1} & {x}_{2} & … & {x}_{m}\end{matrix} ]}^{T} = [ \begin{matrix}{x}_{11} & {x}_{12} & ⋯ & {x}_{1 {n}_{1}} \\ {x}_{21} & {x}_{22} & ⋯ & {x}_{2 {n}_{1}} \\ ⋮ & ⋮ & & ⋮ \\ {x}_{m 1} & {x}_{m 2} & ⋯ & {x}_{{mn}_{1}}\end{matrix} ] \qquad ( 1 )$$

where m and n₁ are the number of variables and samples in the sliding window win_1; x₁ x₂ . . . xₘ represent m variables of the matrix, which are inputs of prediction model;

For the debutanizer column dataset, x₁ x₂ . . . xₘ denote a total of 13 variables, they are top temperature, top pressure, flow of reflux, flow to the next process, temperature of the sixth tray at time t, temperature of the sixth tray at t-1, temperature of the sixth tray at t-2, temperature of the sixth tray at t-3, average value of the temperature at bottom at t, and the butane concentration at t-1, t-2, t-3, and t-4, respectively; The size of m is 13 in this case;

For MSWI process, x₁ x₂ . . . xₘ in represent a total of 10 variables, they are air flow of combustion grate (left side 1-1), air flow of combustion grate (right side 1-1), air flow of dry grate (left side 1-1), primary combustion chamber temperature, primary combustion chamber temperature(left), primary combustion chamber temperature(right), accumulation of primary air flow, accumulation of secondary air flow, accumulation of urea solution, and accumulation of urea solvent supply, respectively; The size of m is 10 in the real industrial data;

The mean vector μ of sample matrix X_{m×n}_{₁}^{win_1} is denoted as:

$$μ = {[ {\overline{μ}}_{1} , {\overline{μ}}_{2} , … , {\overline{μ}}_{m} ]}^{T} \qquad ( 2 )$$

$${\overline{μ}}_{i} = \frac{1}{{n}_{1}} {\sum }_{j = 1}^{{n}_{1}} {x}_{ij} \qquad ( 3 )$$

where μ̅₁, μ̅₂, . . . , μ̅ₘ represent mean value of each row in X_{m×n}_{₁}^{win_1}, and then the mean value of each variable can be obtained by Eq. (3); μ̅ᵢ denotes the i-th value of μ; i=1, 2, . . . , m, and m is the number of variables; xᵢⱼ denote the value of i-th variable in j-th sample; j=1, 2, . . . , n₁, n₁ represents samples number in sliding window with the size of win_1;

All the samples of matrix X_{m×n}_{₁}^{win_1} minus the mean (decentralized) are denoted as

$$\begin{matrix}{\tilde{X}}_{m \times {n}_{1}}^{win \_ 1} = [ \begin{matrix}{x}_{11} {x}_{12} ⋯ {x}_{1 {n}_{1}} \\ {x}_{21} {x}_{22} ⋯ {x}_{2 {n}_{1}} \\ ⋮ \\ {x}_{m 1} {x}_{m 2} ⋯ {x}_{mn 1}\end{matrix} ] - [ \begin{matrix}{\overline{μ}}_{1} , {\overline{μ}}_{1} , … , {\overline{μ}}_{1} \\ {\overline{μ}}_{2} , {\overline{μ}}_{2} , … , {\overline{μ}}_{2} \\ ⋮ \\ {\overline{μ}}_{m} , {\overline{μ}}_{m} , … , {\overline{μ}}_{m}\end{matrix} ] \\ = [ \begin{matrix}{\tilde{x}}_{11} {\tilde{x}}_{12} ⋯ {\tilde{x}}_{1 {n}_{1}} \\ {\tilde{x}}_{21} {\tilde{x}}_{22} ⋯ {\tilde{x}}_{2 {n}_{1}} \\ ⋮ \\ {\tilde{x}}_{m 1} {\tilde{x}}_{m 2} ⋯ {\tilde{x}}_{mn 1}\end{matrix} ] \\ = {[ {\tilde{x}}_{1} , {\tilde{x}}_{2} , … , {\tilde{x}}_{m} ]}^{T}\end{matrix} \qquad ( 4 )$$

where \tilde{X}_{m×n}_{₁}^{win_1} represents the matrix after decentralization, \tilde{x}ᵢⱼ denotes the value of the i-th feature after decentralization in j-th sample, m represents the number of variables, and n is the number of samples contained in sliding window with the size of win_1;

The covariance matrix H_{m×m}^{win_1} of \tilde{X}_{m×n}_{₁}^{win_1} is calculated as:

$${H}_{m \times m}^{win \_ 1} = \frac{1}{{n}_{1} - 1} {\tilde{X}}_{m \times {n}_{1}}^{win \_ 1} \cdot {\tilde{X}}_{m \times {n}_{1}}^{win\_ 1 T} \qquad ( 5 )$$

where \tilde{X}_{m×n}_{₁}^{win_1T} is the transpose of \tilde{X}_{m×n}_{₁}^{win_1};

Then, the eigenvalue λ of covariance matrix H_{m×m}^{win_1} can be calculated as

$$\vert {H}_{m \times m}^{win \_ 1} - λ I \vert = 0 \qquad ( 6 )$$

$$I = [ \begin{matrix}1 & 0 & ⋯ & 0 \\ 0 & 1 & ⋯ & 0 \\ ⋮ & & & \\ 0 & 0 & ⋯ & 1\end{matrix} ] \qquad ( 7 )$$

where I denote the unit matrix; Based on Eq. (6), the eigenvalues of H_{m×m}^{win_1} can be represented as

λ₁≥λ₂≥ . . . ≥λ_{Q} (8)
where Q is the number of eigenvalues; According to Eq. (8), the eigenvector α corresponding to each eigenvalue is calculated as;

(H_{m×m}^{win_1}−λₖI)αₖ=0 (9)
where H_{m×m}^{win_1} is covariance matrix; λₖ denotes the k-th eigenvalue; I is unit matrix, which is represented by Eq. (7); αₖ is eigenvector corresponding to the k-th eigenvalue; αₖ=[α₁ₖ, α₂ₖ, . . . , αₘₖ]^{T}, (k=1, 2, . . . , Q₀);

The threshold of cumulative variance contribution rate is set as θ, and if the cumulative variance satisfies

$${\sum }_{i = 1}^{{Q}_{0}} {λ}_{k} > θ \qquad ( 10 )$$

Then the first Q₀ principal components are selected for further analysis; Q₀ is the number of principal components, which is determined by Eq. (10); The number of eigenvalues is Q₀, which is equal to the number of principal components; λₖ denotes the k-th eigenvalues; Furthermore, the threshold θ is selected as 0.85;

Then, the unit eigenvector α corresponding to Q₀ eigenvalues is used as a coefficient for linear transformation to obtain Q₀ principal components:

zₖ=αₖ^{T}x (11)
where αₖ=[α₁ₖ, α₂ₖ, . . . , αₘₖ]^{T} (k=1, 2, . . . , Q₀)

Combining with the samples in X_{m×n}_{₁}^{win_1}, the principal components of n₁ samples can be obtained by Eq. (11); The k-th principal component zₖⱼ of the j-th sample xⱼ=[x₁ⱼ, x₂ⱼ, . . . , xₘⱼ]^{T} (j=1, 2, . . . , n₁( is

$$\begin{matrix}{z}_{kj} = {[ {α}_{1 k} , {α}_{2 k} , … , {α}_{mk} ] [ {x}_{1 j} , {x}_{2 j} , … , {x}_{mj} ]}^{T} \\ = {\sum }_{i = 1}^{m} {α}_{ik} {x}_{ij}\end{matrix} \qquad ( 12 )$$

where α₁ₖ, α₂ₖ, . . . , zₘₖ denoted the m values of k-th unit eigenvector; x₁ⱼ, x₂ⱼ, . . . , xₘⱼ represent the m variables of j-th sample, respectively; j=1, 2, . . . , n₁, i=1, 2, . . . , m, and k=1, 2, . . . , Q₀;

According to Eq. (12), zₖ that containing k principal components can be denoted by zₖ=[zₖ₁, zₖ₂, . . . , zₖₙ_{₁}]; Therefore, a factor load is defined as the correlation between the k-th principal component zₖ and i-th feature xᵢ, which is calculated as

$$ρ ( {z}_{k} , {x}_{i} ) = \frac{\sqrt{{λ}_{k}} {α}_{ik}}{\sqrt{{σ}_{ii}}} \qquad ( 13 )$$

where αᵢₖ is the unit eigenvector, which denote the i-th value in αₖ; σᵢᵢ is the variance of the i-th variable xᵢ, which is also the i-th diagonal entry of covariance matrix H_{m×m}^{win_1}, k=1, 2, . . . , Q₀, i=1, 2, . . . , m;

The factor load matrix is expressed as

$$ρ = [ \begin{matrix}ρ ( {z}_{1} , {x}_{1} ) & ρ ( {z}_{1} , {x}_{2} ) & ⋯ & ρ ( {z}_{1} , {x}_{m} ) \\ ρ ( {z}_{2} , {x}_{1} ) & ρ ( {z}_{2} , {x}_{2} ) & ⋯ & ρ ( {z}_{2} , {x}_{m} ) \\ & ⋮ & & \\ ρ ( {z}_{q} , {x}_{1} ) & ρ ( {z}_{q} , {x}_{2} ) & … & ρ ( {z}_{q} , {x}_{m} )\end{matrix} ] \qquad ( 14 )$$

Then, the contribution rate σᵢ of Q₀ principal components to the i-th variable xᵢ (i=1, 2, . . . , m) is

$${υ}_{i} = {\sum }_{k = 1}^{{Q}_{0}} {ρ}^{2} ( {z}_{k} , {x}_{j} ) \qquad ( 15 )$$

where the contribution rate υᵢ is the sum of squares of factor loads between the Q₀ principal components and i-th variable xᵢ; Then, the contribution rate matrix υ of Q₀ principal components corresponding to each variable can be expressed as

υ=[υ₁, υ₂, . . . , υₘ] (16)
where m represents the number of variables contained in X_{m×n}_{₁}^{win_1}; The importance of variables changes with the fluctuation of complex operating conditions in MSWI furnace, that is, the contribution rate υᵢ of principal components corresponding to each variable will also change; Therefore, the contribution rate υ is reordered in a descending order

sort(υ)=[υₘₐₓ, . . . , υₘᵢₙ] (17)
where the function of sort(·) is to sort data in a descending order; υₘₐₓ and υₘᵢₙ represent the maximum and minimum value of contribution rate, respectively; The key variables are determined by defining a threshold value ψ;

$$\{ {\sum }_{i = 1}^{F} {υ}_{i} \} > ψ \qquad ( 18 )$$

where the value of ψ is equal to the cumulative variance contribution rate, that is ψ=0.85. F denote the number of key variables, which can be determined by ψ; Equation (18) indicates that the first F variables have the greatest correlation with the principal components in the current window; Then, the first F key features are selected as reference vectors for condition identification, as shown in Eq. (19);

con_1=[x_{num_1}^{win_1}, x_{num_2}^{win_1}, . . . , x_{num_F}^{win_1}] (19)
where x_{num_1}^{win_1}, x_{num_2}^{win_1}, . . . , x_{num_F}^{win_1} represent the first F variables in X_{m×n}_{₁}^{win_1}; Thereafter, the window moves forward by a certain step, and the key variables are detected successively; Finally, the key variables in each sub-task are stored in the knowledge base for modeling analysis, which is expressed as

condition_library=[con_1,con_2, . . . , con_W] (20)
where con_1, con_2, . . . , con_W represent reference vectors corresponding to different operating conditions, respectively; W denotes the number of operating conditions;

The size of sliding window and moving step is selected according to specific data sets; The simulation phase includes a debutanizer column process and a real industrial data of MSWI process; For debutanizer column process, the sliding window size is 600; Considering the dataset is accompanied by slow fluctuations, the moving step of sliding window is set to 300; For MSWI process, the size of sliding window is 600; Considering the complex variation and large fluctuation of the process, the moving step of sliding window is set to 100;

Step 2: Construction of the LSTM-based sub-network;

Aiming each sub-task, LSTM neural network is explored driven by the corresponding key variables; LSTM cell comprises input, forget, output and cell state gate, and each gate is calculated as follows:

Forget gate:

fₜ=σ(W_{f}·[hₜ₋₁, xₜ]+b_{f}) (21)

Input gate:

iₜ=σ(Wᵢ·[hₜ₋₁, xₜ]+bₜ) (22)

Cell state gate:

\tilde{C}ₜ=tan h(W_{c}·[hₜ₋₁, xₜ]+b_{c}) (23)

Cₜ=fₜ⊗Cₜ₋₁+iₜ⊗\tilde{C}ₜ (24)

Output gate:

oₜ=σ(Wₒ[hₜ₋₁, xₜ]+bₒ) (25)

Using Eqs. (21)-(25), the final output of LSTM is

ŷ_{NOx}^{t}=oₜ⊗tan h(Cₜ) (26)
where xₜ denote the input of LSTM neural network at time t; They are air flow of combustion grate (left side 1-1), air flow of combustion grate (right side 1-1), air flow of dry grate (left side 1-1), primary combustion chamber temperature, primary combustion chamber temperature(left), primary combustion chamber temperature(right), accumulation of primary air flow, accumulation of secondary air flow, accumulation of urea solution, accumulation of urea solvent supply at time t, respectively; hₜ₋₁ is the output of LSTM neural network at time t-1; W_{f}, Wᵢ, W_{c} and Wₒ denote the weight matrix of the forget, input, cell state and output gate, respectively; b_{f}, bᵢ, b_{c} and bₒ are the bias of the forget, input, cell state and output gate, respectively; fₜ, iₜ, Cₜ and oₜ represent the output of the forget, input, cell state and output gate, respectively; ŷ_{NOx}^{t} is the output of LSTM neural network at time t; σ(·) and tan h(·) are the activation functions, which are calculated as

$$σ ( U ) = \frac{1}{1 + {e}^{- U}} \qquad ( 27 )$$

$$tanh ( U ) = \frac{{e}^{U} - {e}^{- U}}{{e}^{U} + {e}^{- U}} \qquad ( 28 )$$

where U denote the input of activation function in each gate, as shown in Eqs. (29)-(32):

Forget gate:

U_{f}=W_{f}·[hₜ₋₁, xₜ]+b_{f} (29)

Input gate:

Uᵢ=Wᵢ·[hₜ₋₁, xₜ]+bᵢ (30)

Cell state gate:

U_{c}=W_{c}·[hₜ₋₁, xₜ]+b_{c} (31)

Output gate:

Uₒ=Wₒ·[hₜ₋₁, xₜ]+bₒ (32)

Step 3: Cooperation decision strategy;

During testing stage, the similarity between the i-th testing sample and training samples is measured by Euclidean distance:

d_{g,j}^{test}=dist(x_{g}^{test}, xⱼ^{train}), (j=1, 2, . . . , N) (33)

dist(x_{g}^{test}, xⱼ^{train})=\sqrt{∥x_{g}^{test_1}−xⱼ^{train_1}∥²+ . . . +∥x_{g}^{test_m}−xⱼ^{train_m}∥²} (34)

d_{g}^{test}=[d_{g,1}^{test}, d_{g,2}^{test}, . . . , d_{g,N}^{test}] (35)
where x_{g}^{test} is the g-th sample of testing set; x_{g}^{test_1} and x_{g}^{test_m} denote the first and m-th variable of g-th testing sample, respectively; Similarly, xⱼ^{train_1} and xⱼ^{train_m} denote the first and m-th variable of j-th training sample, respectively; d_{g,1}^{test}, d_{g,2}^{test}, . . . , d_{g,N}^{test} represent Euclidean distance between g-th sample of testing set and samples of training set, respectively; g=1, 2, . . . , G, j=1, 2, . . . , N; N and G denote the number of samples in training and testing sets; According to Eq. (35), the training sample xⱼ^{train} which is closest to testing sample x_{g}^{test} is selected; Then, the operating condition of x_{g}^{test} is determined by that of xⱼ^{train};

Finally, a decision operation strategy is adopted to generate the prediction outputs of MNN during testing phase;

$${\hat{y}}_{NOx} = \frac{{\sum }_{r = 1}^{R} {\hat{y}}_{NOx}^{r}}{R} \qquad ( 36 )$$

where ŷ_{NOx} denote the predicted value of NOx emission, and ŷ_{NOx}^{r} is the output of sub-network; r=1, 2, . . . , R, R represent the number of activated sub-networks;

Step 4: DMNN-based prediction model for NOx emission;

The NOx emission prediction model for MSWI process based on DMNN mainly includes four parts: data preprocessing, PCA-based dynamic task decomposition, construction of sub-network and cooperation decision strategy; As shown in FIG. 3, the original dataset is represented by X^{ori}, and X^{ori}ϵR^{L×m}, where L denotes the number of samples and m is the number of variables; First, the original data is preprocessed via smooth and normalization, and then represented by X^{pre}={x₁ⁱ, x₂ⁱ, . . . , xₘⁱ, y_{NOx}ⁱ}ᵢ₌₁^{N}; Second, to implement a dynamic task decomposition, a sliding window is performed on the training set to determine key variables; Furthermore, the corresponding sub-task is formed in each window; Then, a LSTM-based sub-network is established for sub-task with different key variables as inputs; During the testing phase, the sub-networks are activated using similarity between the testing and the training samples, which is measured via Euclidean distance; And the cooperative decision strategy is used to integrate each activated sub-network to generate the final prediction results of NOx;

In MSWI process, the sensors usually operate in a high temperature and dust environment, which bring the noise to original data; To reduce the effect of the noise on data analysis, Rajda is used to smooth the original data, as shown in Eq. (37);

|x^{ori}−μ^{ori}|≥3σ^{ori} (37)
where x^{ori} denotes original sample, μ^{ori} and σ^{ori} denotes the mean and standard deviation of variables, respectively; The samples satisfying Eq. (37) are regarded as the outliers and removed from the original data; Then, the dataset after smoothing is expressed as X^{smo}, and X^{smo}ϵR^{N×m}; N and m denote the number of samples and variables, respectively;

Z-score method is used to perform standardization on the dataset, which is calculated as Eq. (38);

$${x}_{i} = \frac{{x}_{i}^{smo} - {μ}_{i}^{smo}}{{σ}_{i}^{sm}} \qquad ( 38 )$$

where xᵢ, μᵢ^{smo}, and σᵢ^{smo} (i=1, 2, . . . , m) are the normalized vector, mean and standard deviation of the i-th dimension variable, respectively; The normalized dataset is represented by X_{N×m}^{T}; N and m denote the number of samples and variables, respectively;

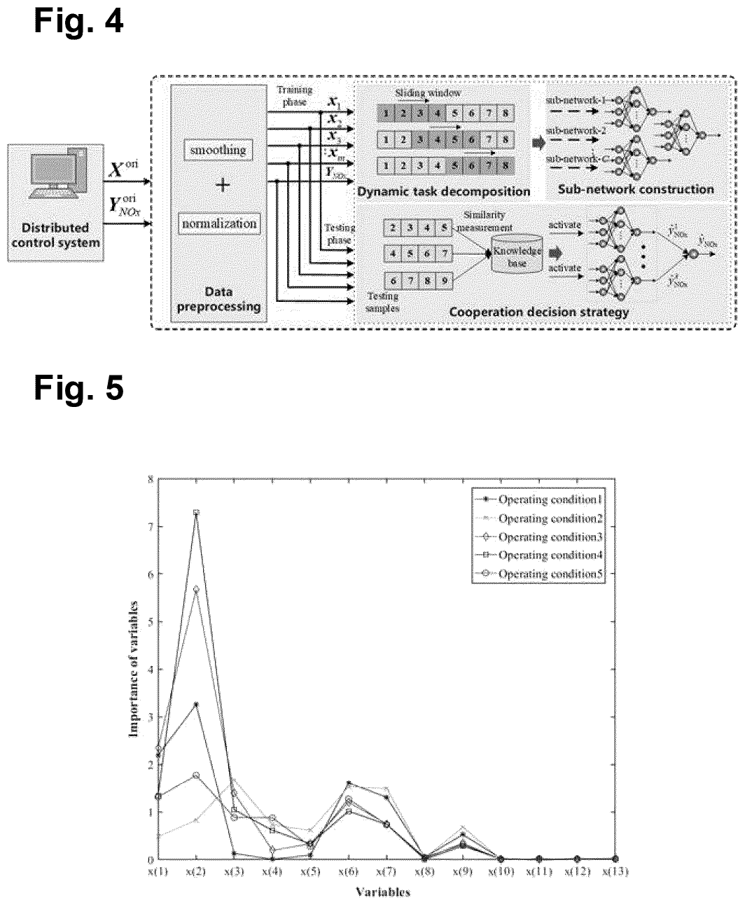

The proposed DMNN-based NOx emission prediction framework for MSWI process (as shown in FIG. 4) is described as follows:

### Training Phase

1) Preprocess the original data ori_data=[X^{ori} Y^{ori}] based on Eqs. (37), (38), and then the dataset is expressed by dataset=[X Y];
2) Set a sliding window with a fixed length of win, and the subset contained in the window is X^{win_1}; The key features of X^{win_1} are constructed by Eqs. (1)-(20); Thereafter, the window moves forward by a certain step, and the key variables are detected successively; Finally, the key variables in each sub-task are stored in the knowledge base for modeling analysis;
3) For each sub-task, LSTM is applied to established the sub-network driven by the corresponding key variables; And the number of hidden neurons is optimized by trial-and-error method;
4) Move the sliding window in steps and repeat step 2)-step 3);

### Testing Phase

5) Calculate the similarity between the test sample and training samples via Eqs. (33)-(35) and generate the outputs of MNN by activating the corresponding the sub-networks;
6) The final prediction result of NOx emission is obtained by integrating the outputs of the sub-networks with a cooperation decision strategy by Eq. (36).

While the invention has been particularly shown and described as referenced to the embodiments thereof, those skilled in the art will understand that the foregoing and other changes in form and detail may be made therein without departing from the spirit and scope.

What is claimed is:

1. A method for dynamic-modular-neural-network (DMNN)-based municipal solid waste incineration (MSWI) process nitrogen oxides (NOx) emission prediction, comprising steps of:
obtaining sensor data associated with an MSWI process, the sensor data comprising a data set comprising a plurality of samples;
preprocessing the sensor data to remove those of the samples that comprise noise and standardizing the data set;
decomposing a task of prediction of a NOx emission associated with an MSWI process into a plurality of sub-tasks using principal component analysis, comprising applying a sliding window of a fixed size to the preprocessed sensor data set and identifying key variables of operating conditions of the MSWI process by key variables by applying a sliding window to the preprocessed sensor data set, each of the key variables associated with one of the sub-tasks:
constructing a long-short-term memory (LSTM) neural network, the LTSM neural network comprising a plurality of sub-networks, wherein each of the sub-networks outputs a value for one of the sub-tasks and a key variable associated with that sub-task serves as an input for that sub-network;
obtaining a further set of sensor data associated with a further MSWI process, the further sensor data comprising further data samples;
comparing at least one of the further samples to at least some of the samples in the preprocessed sensor data set;
activating at least some of the sub-networks based on the comparison; and
using the activated subnetworks in the LTSM network to predict the NOx emission for the further MSWI process, wherein the steps are performed by at least one suitably-programmed computer and wherein a plant associated with the further MSWI process is operated based on the NOx prediction for the further MSWI process.

2. A method according to claim 1, wherein the comparison comprises finding a similarity between the at least one of the further samples and the at least some of the samples in the preprocessed sensor data set.

3. A method according to claim 2, wherein the similarity is determined using Euclidian distance.

4. A method according to claim 1, wherein each sub-network comprises at least one cell that comprises an input, a forget, an output, and a cell state gate.

5. A method according to claim 1, wherein the sensor data is obtained using one or sensors, the sensors comprising one or more a thermocouple temperature sensor, an air volume sensor, a liquid flow sensor, a continuous emission monitoring system, distributed control system and upper computer.

6. A method according to claim 1, wherein the sensor data comprises air flow of combustion grate left side 1-1, air flow of dry grate left side 1, temperature of primary combustion chamber, left side temperature of primary combustion chamber, right side temperature of primary combustion chamber, cumulative primary air flow, cumulative secondary air flow, accumulated urea solution flow, accumulated urea solution supply flow and a NOx emission value associated with the MSWI process.

7. A method according to claim 1, wherein the window moves forward along the preprocessed sensor data set by a step and the key variables are determined successively.

8. A method according to claim 1, wherein the NOx emission for the further MSWI process is predicted in accordance with:
$${\hat{y}}_{NOx} = \frac{{\sum }_{r = 1}^{R} {\hat{y}}_{NOx}^{r}}{R} ,$$
where ŷ_{NOx} denotes the predicted value of the NOx emission, and ŷ_{NOx}^{r} is a sub-network output, and r=1, 2, . . . , R, R represents a number of the activated sub-networks.

9. A method according to claim 1, wherein the at least one suitably-programmed computer receives the further sensor data in real-time.

10. A method according to claim 1, wherein a denitration control system of the plant is controlled based on the for the further MSWI process.

11. A system for dynamic-modular-neural-network (DMNN)-based municipal solid waste incineration (MSWI) process nitrogen oxides (NOx) emission prediction, comprising:
at least one computer configured to:
obtaining sensor data associated with an MSWI process, the sensor data comprising a data set comprising a plurality of samples;
preprocessing the sensor data to remove those of the samples that comprise noise and standardize the data set;
decompose a task of prediction of a NOx emission associated with an MSWI process into a plurality of sub-tasks using principal component analysis, comprising applying a sliding window of a fixed size to the preprocessed sensor data set and identifying key variables of operating conditions of the MSWI process by key variables by applying a sliding window to the preprocessed sensor data set, each of the key variables associated with one of the sub-tasks:
construct a long-short-term memory (LSTM) neural network, the LTSM neural network comprising a plurality of sub-networks, wherein each of the sub-networks outputs a value for one of the sub-tasks and a key variable associated with that sub-task serves as an input for that sub-network;
obtain a further set of sensor data associated with a further MSWI process, the further sensor data comprising further data samples;
compare at least one of the further samples to at least some of the samples in the preprocessed sensor data set;
activate at least some of the sub-networks based on the comparison; and
use the activated subnetworks in the LTSM network to predict the NOx emission for the further MSWI process, wherein a plant associated with the further MSWI process is operated based on the NOx prediction for the further MSWI process.

12. A system according to claim 11, wherein the comparison comprises finding a similarity between the at least one of the further samples and the at least some of the samples in the preprocessed sensor data set.

13. A system according to claim 12, wherein the similarity is determined using Euclidian distance.

14. A system according to claim 11, wherein each sub-network comprises at least one cell that comprises an input, a forget, an output, and a cell state gate.

15. A system according to claim 11, wherein the sensor data is obtained using one or sensors, the sensors comprising one or more a thermocouple temperature sensor, an air volume sensor, a liquid flow sensor, a continuous emission monitoring system, distributed control system and upper computer.

16. A system according to claim 11, wherein the sensor data comprises air flow of combustion grate left side 1-1, air flow of dry grate left side 1, temperature of primary combustion chamber, left side temperature of primary combustion chamber, right side temperature of primary combustion chamber, cumulative primary air flow, cumulative secondary air flow, accumulated urea solution flow, accumulated urea solution supply flow and a NOx emission value associated with the MSWI process.

17. A system according to claim 11, wherein the window moves forward along the preprocessed sensor data set by a step and the key variables are determined successively.

18. A system according to claim 11, wherein the NOx emission for the further MSWI process is predicted in accordance with:
$${\hat{y}}_{NOx} = \frac{{\sum }_{r = 1}^{R} {\hat{y}}_{NOx}^{r}}{R} ,$$
where ŷ_{NOx} denotes the predicted value of the NOx emission, and ŷ_{NOx}^{r} is a sub-network output, and r=1, 2, . . . , R, R represents a number of the activated sub-networks.

19. A system according to claim 11, wherein the at least one suitably-programmed computer receives the further sensor data in real-time.

20. A system according to claim 11, wherein a denitration control system of the plant is controlled based on the for the further MSWI process.
